(19) United States
(12) Patent Application Publication
(10) Pub. No.: US 2011/0238353 A1
(43) Pub. Date: Sep. 29, 2011

(54) SYSTEM AND METHOD FOR CHECKING A MEASURING DEVICE

(75) Inventor: Fa-Sheng Huang, Shenzhen City (CN)

(73) Assignees: HONG FU JIN PRECISON INDUSTRY (Shenzhen) CO., LTD., SHENZHEN CITY (CN); HON HAI PRECISION INDUSTRY CO., LTD., TU-CHENG (TW)

(21) Appl. No.: 12/824,209

(22) Filed: Jun. 27, 2010

(30) Foreign Application Priority Data
Mar. 24, 2010 (CN) 201010131030.8

(51) Int. Cl. G06F 19/00

(52) U.S. Cl. 702/104

(57) ABSTRACT

A measuring device includes a method used to calibrate the measuring device before the measuring device is operational. If an output voltage of the measuring device is not in a standard voltage range, the output voltage is adjusted. If a calibration status is a successful status, selected test channels of the measuring device are prompted to connect with a test probe. If the calibration status is an unsuccessful status, a calibration unit of the measuring device calibrates the measuring device until the calibration status is a successful status. The calibration unit calibrates the selected test channels according to a set compensation value by a user.

### BACKGROUND

1. Technical Field

Embodiments of the present disclosure relate to measuring devices, and more particularly to a system and a method for checking a measuring device.

2. Description of Related Art

If a measuring device is not working properly due to static electricity build-up, or if the measuring device is not outputting the precise voltage, the measuring device will not be accurate. Thus, in important applications, measuring devices need to be checked and calibrated before use. However, people may forget to check and calibrate or do it improperly.

What is needed, therefore, is an improved system and method for checking a measuring device.

### BRIEF DESCRIPTION OF THE DRAWINGS

FIG. 1 is a block diagram of one embodiment of a measuring device comprising a check system.

FIG. 2 is a block diagram showing functional modules of the check system of FIG. 1.

FIG. 3 is a flowchart of one embodiment of a method for checking a measuring device.

### DETAILED DESCRIPTION

The processes described may be embodied in, and fully automated via, functional modules executed by one or more general purpose processors. The functional modules may be stored in any type of computer-readable medium or other computer storage device. Some or all of the methods may alternatively be embodied in specialized computer hardware or communication apparatus.

As used herein, the terms “skew” or “skewed” are defined to include deviation from a working standard of a test device or components of the test device. The deviation may include numerical range and accord to a determined engineering tolerance.

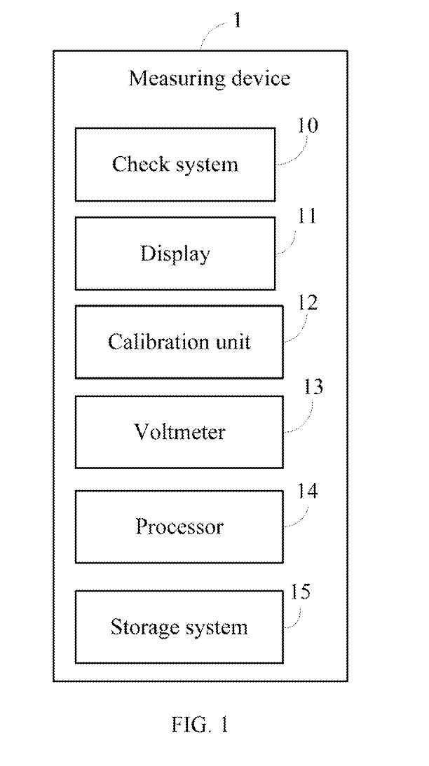

FIG. 1 is a block diagram of one embodiment of a measuring device 1 comprising a check system 10. The check system 10 may be used to verify characteristics of the measuring device 1 before the measuring device 1 is used. In one embodiment, the measuring device 1 may be an oscillograph, or a network analyzer, for example. The verification may include checking voltage and/or static electricity of the measuring device 1, for example. If the verification of the measuring device 1 is complete, the measuring device 1 is ready to be used. The measuring device 1 includes a display 11, a calibration unit 12, and a voltmeter 13. The calibration unit 12 calibrates test channels and test probes of the measuring device 1. The voltmeter 13 measures an output voltage of the measuring device 1.

The measuring device 1 includes a processor 14 and a storage system 15. It may be understood that one or more specialized or general purpose processors, such as the processor 14, may be used to execute one or more computerized codes of function modules of the check system 10. The one or more computerized codes of the functional modules may be stored in the storage system 15. The storage system 26 also stores a standard voltage range and a calibration status of the measuring device 1. The calibration status may be a successful status or an unsuccessful status. If the calibration status is the successful status, it is represented that the measuring device 1 has been calibrated successfully by the calibration unit 12. Likewise, if the calibration status is the unsuccessful status, it is represented that the measuring device 1 has not been calibrated successfully by the calibration unit 12.

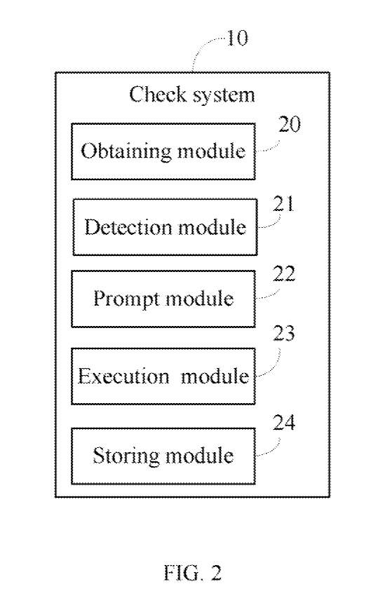

FIG. 2 is a block diagram of functional modules of the check system 10 of FIG. 1. In one embodiment, the check system 10 may include an obtaining module 20, a detecting module 21, a prompt module 22, an execution module 23, and a storing module 24.

The obtaining module 20 obtains an output voltage of the measuring device measured by the voltmeter 13 of the measuring device 1.

The detection module 21 detects if the output voltage is within a standard voltage range. If the output voltage is within the standard voltage range, the detection module 21 determines that the output voltage of the measuring device 1 is normal. If the output voltage is not within the standard voltage range, the detection module 21 determines that the output voltage is abnormal. For example, if the output voltage is 210V and the standard voltage range is 220V˜230V, the detection module 21 determines that the output voltage is normal.

If the output voltage is not within the standard voltage range, the prompt module 22 prompts a user to turn off the measuring device 1 and adjusts the output voltage. In one embodiment, the prompt module 22 can display a dialog box on the display 11 prompting the user to take appropriate action such as to adjust output voltage of the measuring device 1. The prompt module 22 may also display a prompt on the display 11 to remind the user to protect themselves and the measuring device 1 from static electricity. The obtaining module 20 obtains the calibration status of the measuring device 1 from the storage system 15.

The detection module 21 detects if the calibration status of the measuring device 1 is the successful status. If the calibration status is the unsuccessful status, the execution module 23 uses the calibration unit 12 to calibrate the measuring device 1. The storing module 24 updates the calibration status of the measuring device 1 in the storage system 15.

The obtaining module 20 receives test channels of the measuring device 1 selected by the user. The detection module 21 detects if each of the selected test channels is connected to a test probe. If there are any of the selected test channels not connected to corresponding test probes, the prompt module 22 prompts the user to connect each of the selected test channels to the test probe.

If all the selected test channels are connected to the test probes, the detection module 21 detects if any of the selected test channels are skewed. If one of the selected test channels are skewed, the obtaining module 20 obtains a set compensation value, for example input by a user. It should be understood that the test channels may not be reading accurate enough values, thus the test channels are skewed and should be compensated (e.g., calibrated), to accord with a determined working standard of the test channels of the measuring device 1. The calibration unit 12 calibrates the selected channel according to the set compensation value.

The storing module 24 stores check results of checking the measuring device 1 to the storage system 26. In one embodiment, the check results may include, but are not limited to, the compensation value of each of the selected test channels, calibration results of the measuring device 1, and connection information of the test probes corresponding to the selected test channels.

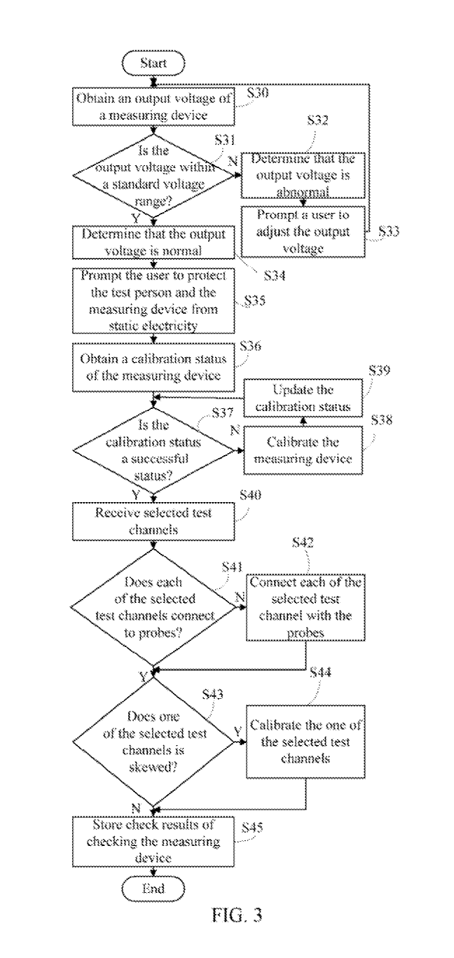

FIG. 3 is a flowchart of one embodiment of a method for checking the measuring device 1. Depending on the embodiment, additional blocks may be added, others removed, and the ordering of the blocks may be changed.

In block S30, the obtaining module 20 obtains an output voltage of the measuring device 1 measured by the voltmeter 13 of the measuring device 1.

In block S31, the detection module 21 detects if the output voltage is within the standard voltage range of the measuring device 1. If the output voltage is within the standard voltage range, block S34 is implemented. If the output voltage is not within the standard voltage range, block S32 is implemented.

In block S32, the detection module 21 determines that the output voltage is abnormal In block S33, the prompt module 22 prompts a user to turn off the measuring device 1 and adjust the output voltage, and block S30 is repeated.

In block S34, the detection module 21 determines that the output voltage of the measuring device 1 is normal.

In block S35, the prompt module 22 prompts the user to protect the measuring device 1 and users from static electricity

In block S36, the obtaining module 20 obtains the calibration status from the storage system 26.

In block S37, the detection module 21 detects if calibration status is the successful status. If the calibration status is the unsuccessful status, in block S38, the execution module 23 uses the calibration unit 12 to calibrate the measuring device 1. If the calibration status is the successful status, in block S39, the storing module 24 updates the calibration status in the storage system 26.

In block S40, the obtaining module 20 obtains test channels of the measuring device 1 selected by the user.

In block S41, the detection module 21 detects if each of the selected test channels is connected to a test probe. If there are any of the selected test channels not connected to corresponding test probes, in block S42, the prompt module 22 prompts to connect each of the selected test channels to the test probe. If all the selected test channels are connected to the test probes, block S43 is implemented.

In block S43, the detection module 21 detects if any selected test channels are skewed. If the selected test channels are skewed, block S44 is implemented. If each of the selected test channels are not skewed, block S45 is implemented.

In block S44, the obtaining module 20 obtains a set compensation value by the user, and the calibration unit 12 calibrates the selected test channels according to the set compensation value.

In block S45, the storing module 24 stores check results of checking the measuring device 1 to the storage system 26. In one embodiment, the check results may include, but are not limited to, the compensation value of each of the selected test channel, calibration results of the measuring device 1, and connection information of the test probes corresponding to the selected test channels.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A measuring device, comprising:
a storage system; and
at least one processor to execute one or more programs stored in the storage system, the one or more programs comprising:
an obtaining module operable to obtain an output voltage measured by a voltmeter of the measuring device and a calibration status of the measuring device;
a prompt module operable to prompt a user to turn off the measuring device and adjust the output voltage if the output voltage is not within a standard voltage range;
an execution module operable to use a calibration unit of the measuring device to calibrate the measuring device if the calibration status of the measuring device is an unsuccessful status;
the obtaining module further operable to receive selected test channels of the measuring device;
the prompt module further operable to prompt the user to connect each of the selected test channels to test probes of the measuring device if the selected test channels have not been connected to the test probes; and
the obtaining module further operable to obtain a set compensation value of one of the selected test channels which is skewed, and control the calibration unit to calibrate the one of the selected test channel according to the set compensation value.

2. The measuring device of claim 1, further comprising a storing module operable to store the compensation value of each of the selected test channels and connection information of the test probe corresponding to each of the selected test channels.

3. The measuring device of claim 1, wherein the storing module further updates the calibration status of the measuring device after the measuring device is calibrated.

4. A method for checking a measuring device, the method comprising:
obtaining an output voltage measured by a voltmeter of the measuring device and a calibration status of the measuring device;
prompting a user to turn off the measuring device and adjusting the output voltage if the output voltage is not within a standard voltage range of the measuring device until the output voltage is within the standard voltage range;
using a calibration unit of the measuring device to calibrate the measuring device if the calibration status of the measuring device is an unsuccessful status until the calibration status of the measuring device is a successful status;
receiving selected test channels of the measuring device;
prompting the user to connect each of the selected test channels to test probes of the measuring device if the selected test channels have not been connected to the test probes; and
obtaining a set compensation value of one of the selected test channels which is skewed, and controlling the calibration unit to calibrate the selected test channel according to the set compensation value.

5. The method of claim 4, further comprising: storing the compensation value of each of the selected test channels and connection information of the test probe corresponding to each of the selected test channels into a storage system of the measuring device.

6. The method of claim 4, further comprising updating the calibration status of the measuring device after the measuring device is calibrated.

7. A storage medium having stored thereon instructions that, when executed by a processor of a computer, causes the computer to perform a method for checking a measuring device, the method comprising:
obtaining an output voltage measured by a voltmeter of the measuring device and a calibration status of the measuring device;
prompting a user to turn off the measuring device and adjusting the output voltage if the output voltage is not within a standard voltage range of the measuring device until the output voltage is within the standard voltage range;
using a calibration unit of the measuring device to calibrate the measuring device if the calibration status of the measuring device is an unsuccessful status until the calibration status of the measuring device is a successful status;
receiving selected test channels of the measuring device;
prompting the user to connect each of the selected test channels to test probes of the measuring device if the selected test channels have not been connected to the test probes; and
obtaining a set compensation value of one of the selected test channels which is skewed, and controlling the calibration unit to calibrate the selected test channel according to the set compensation value.

8. The medium of claim 7, further comprising: storing the compensation value of each of the selected test channels and connection information of the test probe corresponding to each of the selected test channels into a storage system of the measuring device.

9. The medium of claim 7, further comprising updating the calibration status of the measuring device after the measuring device is calibrated.
